(19) United States
(12) Patent Application Publication
(10) Pub. No.: US 2016/0007184 A1
(43) Pub. Date: Jan. 7, 2016

(54) IDENTIFYING COMPUTER DEVICES IN PROXIMITY TO A GIVEN ORIGIN

(71) Applicant: RADIUS MOBILE, INC., San Francisco, CA (US)

(72) Inventor: Vitaliy KULIKOV, San Francisco, CA (US)

(21) Appl. No.: 14/769,786

(22) PCT Filed: Feb. 24, 2014
(86) PCT No.: PCT/US14/18056

§ 371 Date: Aug. 21, 2015

Related U.S. Application Data
(60) Provisional application No. 61/769,075, filed on Feb. 25, 2013.
(60) Provisional application No. 61/771,630, filed on Mar. 1, 2013.
(60) Provisional application No. 61/805,617, filed on Mar. 27, 2013.

(51) Int. Cl. H04W 8/00; H04W 4/02; H04W 4/00

(52) U.S. Cl. CPC H04W 8/005; H04W 4/008; H04W 4/021

(57) ABSTRACT

A proximity detector running on a server receives a first beacon signature from a first client device, the first beacon signature indicating a plurality of beacons detected by the first client device. The proximity detector determines a second beacon signature associated with a second client device, wherein the second client device is associated with at least one of the plurality of beacons detected by the first client device, and compares the first beacon signature to the second beacon signature. The proximity detector determines a proximity of the first client device and the second client device in view of the comparing of the first beacon signature and the second beacon signature.

### TECHNICAL FIELD

This disclosure relates to the field of proximity detection and, in particular, to identifying computer devices in proximity to a given origin.

### BACKGROUND

Location-based services are a general class of computer program-level services used to include specific controls for location and time data as control features in computer application programs. As such, location-based services have a number of uses in social networking today as an entertainment service, which is accessible with mobile devices through the mobile network and which uses information on the geographical position of the mobile device.

### BRIEF DESCRIPTION OF THE DRAWINGS

The present disclosure is illustrated by way of example, and not by way of limitation, in the figures of the accompanying drawings.

FIG. 1 is a block diagram illustrating a computing environment for identifying computer devices in proximity to a given origin, according to an embodiment.

FIG. 2 is a block diagram illustrating a client device for identifying computer devices in proximity to a given origin, according to an embodiment.

FIG. 3 is a map diagram illustrating a cluster of client devices and the coverage areas of multiple beacons used to determine the proximity of the client devices, according to an embodiment.

FIG. 4 is a block diagram illustrating a server-side proximity detector, according to an embodiment.

FIG. 5 is a diagram illustrating device records for storing beacon signatures, according to an embodiment.

FIGS. 6A and 6B are diagrams illustrating beacon records for storing beacon signatures, according to embodiments.

FIG. 7 is a diagram illustrating results of a comparison of beacon signatures for determining device proximity, according to an embodiment.

FIG. 8 is a flow diagram illustrating method for client-side proximity detection, according to an embodiment.

FIG. 9 is a flow diagram illustrating method for server-side proximity detection, according to an embodiment.

FIG. 10 is a flow diagram illustrating method for client-side location propagation, according to an embodiment.

FIG. 11 is a flow diagram illustrating method for server-side location propagation, according to an embodiment.

FIG. 12 is a block diagram illustrating a computer system, according to an embodiment.

### DETAILED DESCRIPTION

The following description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the scope of the present invention.

Embodiments are described for identifying computer devices in proximity to a given origin. In one embodiment, a client device, such as a mobile phone, includes a beacon detector that detects visible signal beacons. The beacons can include, for example, signals from Wi-Fi access points, such as stationary or mobile wireless access points, Bluetooth signals from other wireless devices, or other signals. A beacon signature module in the client device generates a beacon signature indicating the beacons detected by the beacon detector. In one embodiment, each beacon has a unique identifier, and the beacon signature includes a list, concatenation, or other format including the unique identifier of each beacon detected by the beacon detector. In other embodiments, the beacon signature additionally includes an indication of the signal strength of each detected beacon, an indication of the beacon type and/or a timestamp indicating when the beacon was detected. The client device may send the beacon signature to a server periodically, in response to a request from the server, or in response to a change in the beacon signature.

In one embodiment, the server receives the beacon signature from the client device and similarly receives beacon signatures from other client devices. The server can use these received beacon signatures to determine the relative proximity of the client devices to one another. In one embodiment, a proximity detector in the server determines other client devices that are associated with at least one of the beacons detected by the first client device. The proximity detector identifies the beacon signatures of those other client devices and compares the beacon signature to that of the first client device (i.e., the “origin device”). In one embodiment, the signature handling module determines a number of beacons that are shared between any two beacon signatures and uses that number as a measure of proximity of the corresponding client devices (e.g., the higher the number of shared beacons, the closer the devices are to one another). The signature handling module further determines a subset of the other client devices for which the beacon signatures satisfy a proximity threshold with respect to the beacon signature of the first client device. For example, the proximity threshold may specify a minimum number of beacons (e.g., two beacons, three beacons or some other number of beacons) that should be shared between the beacon signatures in order to determine a sufficient proximity. In one embodiment, the signature handling module generates an ordered list of the subset of client devices that satisfy the proximity threshold and provides the ordered list to the first client device.

The client device may receive the ordered list of other client devices that are in a given proximity. The beacon-based method described herein can be used efficiently to estimate relative proximity of the client devices. It is cheap, it works indoors, and it is sensitive enough to identify and rank devices in very close proximity (e.g., within 10-20 meters). This allows the user of the client device to determine other devices (and through the use of user profiles, other individuals) who are in a relatively close proximity (e.g., within the same bar, restaurant, venue, etc.).

In one embodiment, in addition to the proximity functionality, which determines relative proximity of client devices rather than their actual locations, the system described herein can leverage the proximity functionality to propagate location coordinates among client devices. In one embodiment, each client device periodically determines location coordinates that define its actual location (e.g., using GPS, Wi-Fi triangulation, cell tower triangulation, or other methods). For certain devices, GPS may not be constantly enabled due to the potential battery drain. In one embodiment, when the server determines that two client devices are within a certain proximity of another based on the comparison of their beacon signatures, the server can share the location coordinates of one device with the other. If one device has more recently obtained GPS coordinates than the other device, the server can provide those GPS coordinates to the other device which can use the updated coordinates for its associated location services. The updated location coordinates are likely more accurate with respect to the current location of both devices since they were obtained more recently than the device's own prior coordinates.

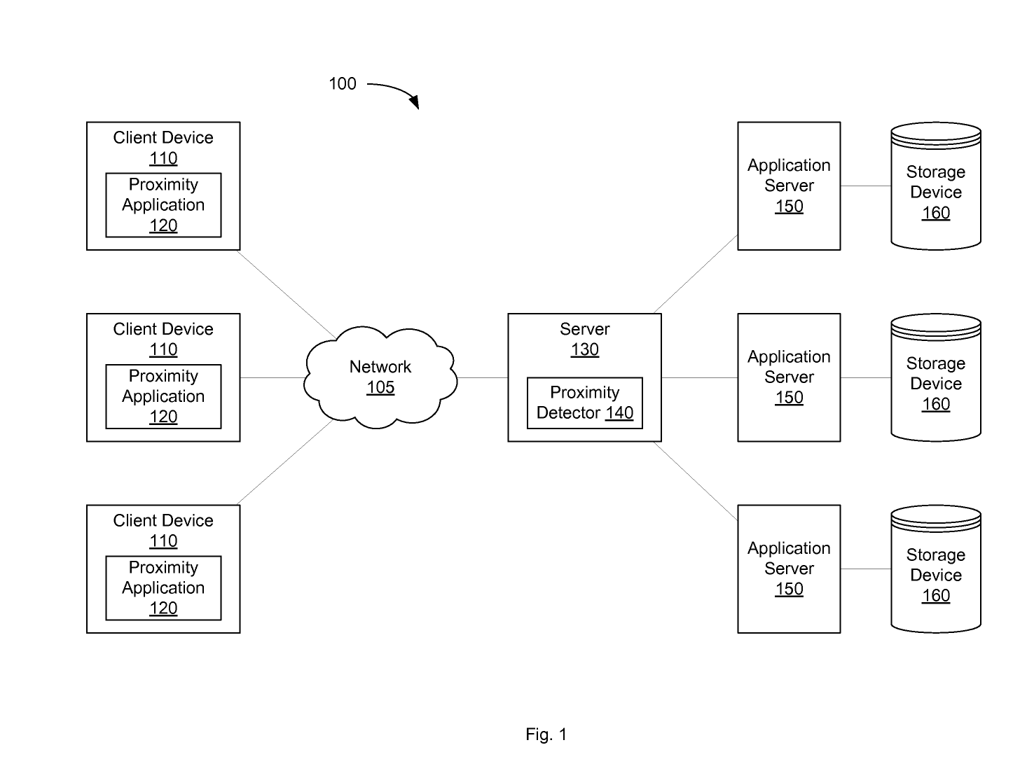

FIG. 1 is a block diagram illustrating a computing environment for identifying computer devices in proximity to a given origin, according to an embodiment. In one embodiment, computing environment 100 includes multiple client devices 110 and one or more servers 130. Client devices 110 and server 130 may be connected through a series of one or more networks 105, which may be, for example, a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof. In another embodiment, client devices 110 and server 130 may have a direct connection between them. The illustrated embodiment shows three client devices 110 and one server 130, however, in other embodiments, there may be any number of client devices and servers, and computing environment 100 may include additional and/or different devices.

Each client device 110 may be, for example, a personal computer (PC), workstation, laptop computer, tablet computer, mobile phone, personal digital assistant (PDA) or the like. In one embodiment, client devices 110 may each include transmitter used to provide signals to server 130 over network 105. The transmitted signals may include, for example, radio-frequency identification (RFID) signals, Bluetooth signals, near field communication (NFC) signals, mobile communications signals, or some other type of communications signal. In one embodiment, client devices 110 each include a receiver to receive signals from server 130. The received signals may be of the same or similar type as the transmitted signals. Each client device 110 may also include a beacon detector to detect beacons in the vicinity of the client device 110. The beacons can include, for example, Wi-Fi access points, such as stationary or mobile wireless access points. Additionally, in one embodiment, each client device 110 may include a proximity application 120. The proximity application 120 can generate a beacon signature using the beacons detected by the beacon detector and provide the beacon signature to server 130 over network 105. In return, proximity application 120 can receive an indication of other client devices 110 that are in proximity to the client device 110 running proximity application 120. Additional details of proximity application 120 are provided below.

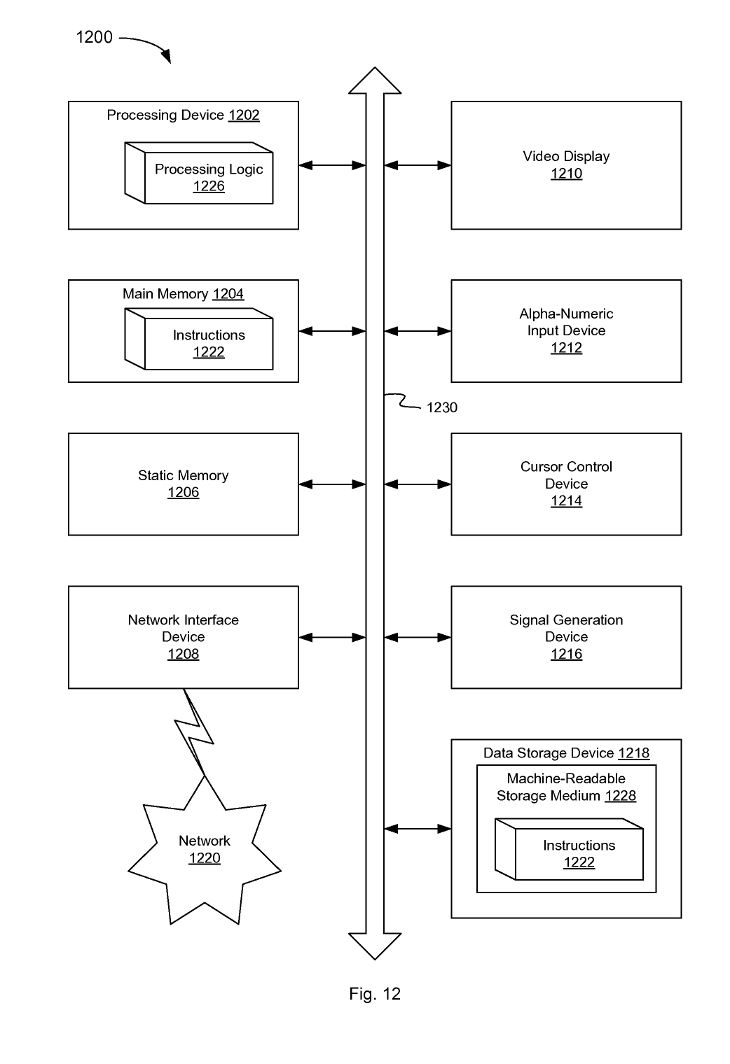

Server 130 may be any computing device, such as computing system 1200, described below with respect to FIG. 12. In one embodiment, server 130 may include one or more computing devices (such as a rack mount server, a router computer, a server computer, a personal computer, a mainframe computer, a laptop computer, a tablet computer, a desktop computer, etc.), data stores (e.g., hard disks, memories, databases), networks, software components, and/or hardware components. In one embodiment, server 130 may include proximity detector 140. Proximity detector 140 can communicate with the proximity applications 120 in each of client devices 110 to receive a beacon signature and determine other client device 110 that are in proximity to a given client device 110. Proximity detector 140 can provide an indication of these client devices 110 to the requesting client device 110. Additional details of proximity detector 140 are provided below. In one embodiment, server 130 may be an endpoint of a distributed server system. The distributed server system may include physical computing devices (e.g., multiple application servers 150) and multiple storage components 160 (e.g., multiple drives or multiple databases). In one embodiment, the each storage component 160 may be a memory (e.g., random access memory), a cache, a drive (e.g., a hard drive), a flash drive, a database system, or another type of component or device capable of storing data.

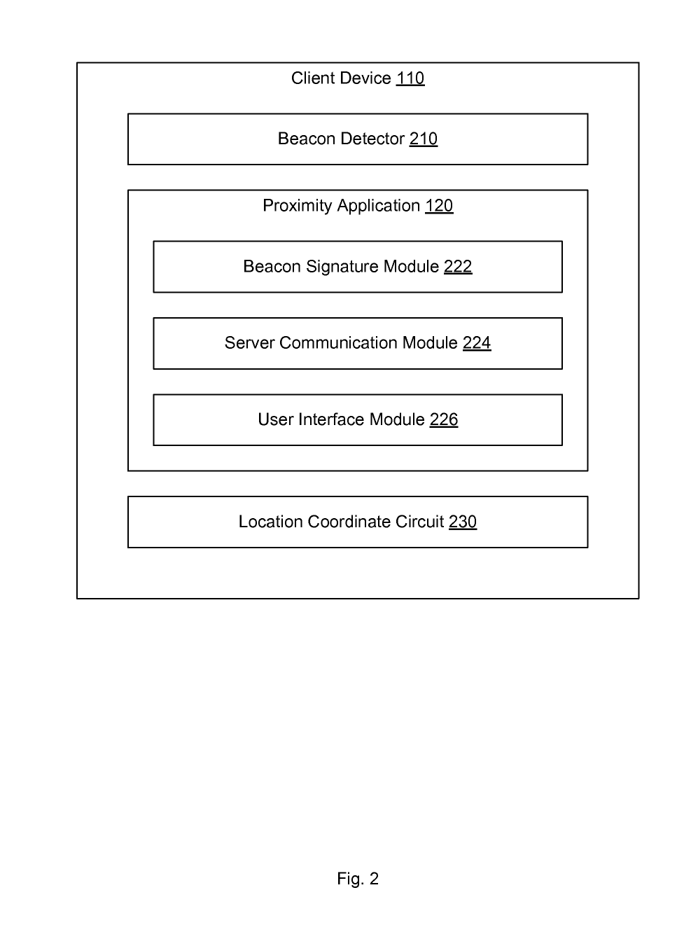

FIG. 2 is a block diagram illustrating a client device for identifying computer devices in proximity to a given origin, according to an embodiment. In one embodiment, client device 110 may be representative of one of client devices 110, as shown in FIG. 1. In one embodiment, client device 110 includes beacon detector 210, proximity application 120 and location coordinate circuit 230. This arrangement of modules and components may be a logical separation, and in other embodiments, these modules or other components can be combined together or separated in further components, according to a particular implementation. In other embodiments, client device 110 may include different and/or additional components which are not shown to simplify the description.

In one embodiment, beacon detector 210 detects beacons that are “visible” to the client device 110. The beacons can include, for example, signals from Wi-Fi access points, such as stationary or mobile wireless access points, Bluetooth signals from other wireless devices, or other signals. A beacon may be “visible” to client device 110 when client device 110 is within range of the beacon and beacon detector 210 is able to detect the presence of the signal. Client device 110 need not necessarily be connected to a network associated with a beacon in order for that beacon to be “visible.” Detection of the beacon is sufficient. Beacon detector 210 may also determine the signal strength of a detected beacon. In general, the stronger a detected signal beacon is, the closer the client device 110 is to the source. Alternatively, a stronger signal beacon may be indicative of a more powerful signal generator. Furthermore, beacon detector 210 may also determine the type of beacon detected (e.g., stationary or mobile wireless access point, Bluetooth signal, etc.). Depending on the embodiment, beacon detector 210 may include a mobile communications, cellular, or Bluetooth chipset, radio, circuit, receiver, transceiver or other communications device. In one embodiment, beacon detector 210 includes any component capable of detecting the presence of a communication signal.

In one embodiment, proximity application 120 includes beacon signature module 222, server communication module 224 and user interface module 226. Beacon signature module 222 generates a beacon signature indicating the beacons detected by beacon detector 210. In one embodiment, each beacon has a unique identifier. For example, the unique identifier may be a basic service set identifier (BSSID) for a Wi-Fi beacon or a hardware device address (BD_ADDR) for a Bluetooth beacon. In one embodiment, the beacon signature includes a list, concatenation, or other format including the unique identifier of each beacon detected by beacon detector 210. In other embodiments, the beacon signature additionally includes an indication of the signal strength of each detected beacon, an indication of the beacon type and/or a timestamp indicating when the beacon was detected. In some embodiments, the size of each beacon signature can also be made smaller. Instead of using the full beacon identifiers as part of the device signature, beacon signature module 222 can generate and use significantly smaller hashes of the beacon identifiers. In one embodiment, beacon signature module 222 generates a new beacon signature upon request from the user or another application. In one embodiment, beacon signature module 222 generates a new or updates a previous beacon signature periodically or in response to a change in the beacons detected by beacon detector 210.

In some embodiments, beacon signature module 222 can generate a smaller signature by selecting and including a subset of the detected beacons as part of the beacon signature. In one embodiment, the decision of which beacons to select can be made based on an indication of strength of each detected beacon, an indication of the beacon type, and/or a timestamp indicating when the beacon was detected or last-reported to the server 130. In one embodiment, beacon signature module 222 may limit the number of beacons in the signature, so as not to exceed a certain maximum.

In some embodiments, including a subset of the detected beacons as part of the smaller beacon signature may disproportionally reduce the number of beacon matches in signatures of devices in proximity to one another. For example, if different subsets of the same set of beacons are selected, it is possible for signatures based on those subsets to have few or no beacons in common.

In some embodiments, for devices in proximity to one another, the expected number of beacon matches in signatures can be increased by having all instances of the beacon signature module 222 follow a deterministic beacon selection procedure based on intrinsic properties of beacons detected. In one embodiment, beacon signature module 222 can decide what beacons to include as part of the smaller signature by using a beacon selection procedure based on beacon identifiers.

In one embodiment, beacon signature module 222 can generate the signature from up to a certain maximum of beacons, with preference given to beacons with identifiers that are smaller. In another embodiment, beacon signature module 222 can generate the signature from up to a certain maximum of beacons, with preference given to beacons with identifiers that are larger. In one embodiment, beacon signature module 222 can compute a hash of each beacon identifier and generate the signature from up to a certain maximum of beacons, with preference given to beacons with hashes that are smaller. In another embodiment, beacon signature module 222 can compute a hash of each beacon identifier and generate the signature from up to a certain maximum of beacons, with preference given to beacons with hashes that are larger. In one embodiment, absolute value of the first 8 bytes of MURMUR3_{—}128 hash converted to a Java long type value in little-endian order can be used, with the same MURMUR3_{—}128 hash seed used across all of the instances of the beacon signature module. In other embodiments, a cryptographically-secure hash function can be used.

In some embodiments, beacon signature module 222 assigns each beacon a weight, and the extent of proximity between devices can be estimated as the sum of weights across beacons that the devices have in common between their respective signatures. In some embodiments, each beacon can be assigned a fixed weight of one, in which case the number of beacons that the devices have in common between their respective signatures is used as the measure of proximity between the devices. In other embodiments, the weight of each beacon can be computed dynamically, using information such as the type of beacon, the strength of the detected beacon signal, or a historical degree of agreement between the beacon and other beacons. In one embodiment, beacons from mobile Wi-Fi access points may be weighted higher because mobile Wi-Fi access points typically have a weaker signal generator, such that client devices that can detect the beacon from the mobile Wi-Fi access point are generally closer in proximity to the source of the beacon. Thus, two client devices that both detect the beacon from the same mobile Wi-Fi access point are likely to be closer in proximity to one another. The reverse is generally true for stationary Wi-Fi access points, which may be weighted lower. Stationary Wi-Fi access points typically have a more powerful signal generator, such that client devices that can detect the beacon from the stationary Wi-Fi access point are not necessarily close in proximity to the source of the beacon or close in proximity to one another.

In some embodiments, each device signature can be represented as a vector in a linear multi-dimensional space, with each beacon representing a different dimension and the signal-strength from the beacon as sensed by the beacon detector 210 used as the vector coordinate in that dimension. For beacons not present in the signature, the coordinate can be assigned a weight of zero. The extent of proximity between a device and the origin can then be estimated as the dot product between their respective signature vectors.

In one embodiment, server communication module 224 provides the beacon signatures generated by beacon signature module 222 to server 130. Server communication module 224 may send the beacon signature to server 130 periodically, in response to a request from server 130, or in response to a change in the beacon signature by beacon signature module 222. In addition, server communication module 224 may receive communications from server 130. In one embodiment, server communication module 224 may receive an indication of one or more other client devices that are in proximity to the client device 110. The indication may include an ordered list of other client devices arranged based on their proximity to the client device 110. In one embodiment, server 130 may determine the proximity based on a comparison of the beacon signatures from the various client devices 110. The higher the number of beacons that are shared between two beacon signatures, the closer in proximity the associated client devices 110 are to one another.

In one embodiment, user interface module 226 presents a user interface (e.g., on a display of client device 110) to provide the proximity information received by server communication module 224 from server 130. In one embodiment, user interface module 226 may display the ordered list of client devices received from server 130. In addition to the client devices, user interface module 226 may display profile information for a user corresponding to each of the client devices.

In one embodiment, location coordinate circuit 230 is operable to determine location coordinates of the client device 110. Location coordinate circuit 230 may determine the location coordinates in a number of ways including, for example, the Global Positioning System (GPS), cellular triangulation using the location of known cellular network towers, Wi-Fi triangulation using the location of known stationary Wi-Fi access points, or other techniques. Location coordinate circuit 230 may be used to determine an actual location of client device 110, rather than just the relative proximity to other client device. Location coordinate circuit 230 may be a resource intensive component (e.g., using higher amounts of power and network bandwidth, thereby decreasing battery life in client device 110). Accordingly, rather than being always active, in some embodiments, location coordinate circuit 230 may only be activated to determine the location coordinates periodically (e.g., every 30 minutes) or in response to a specific request from the user, in response to a request from the server, or another application.

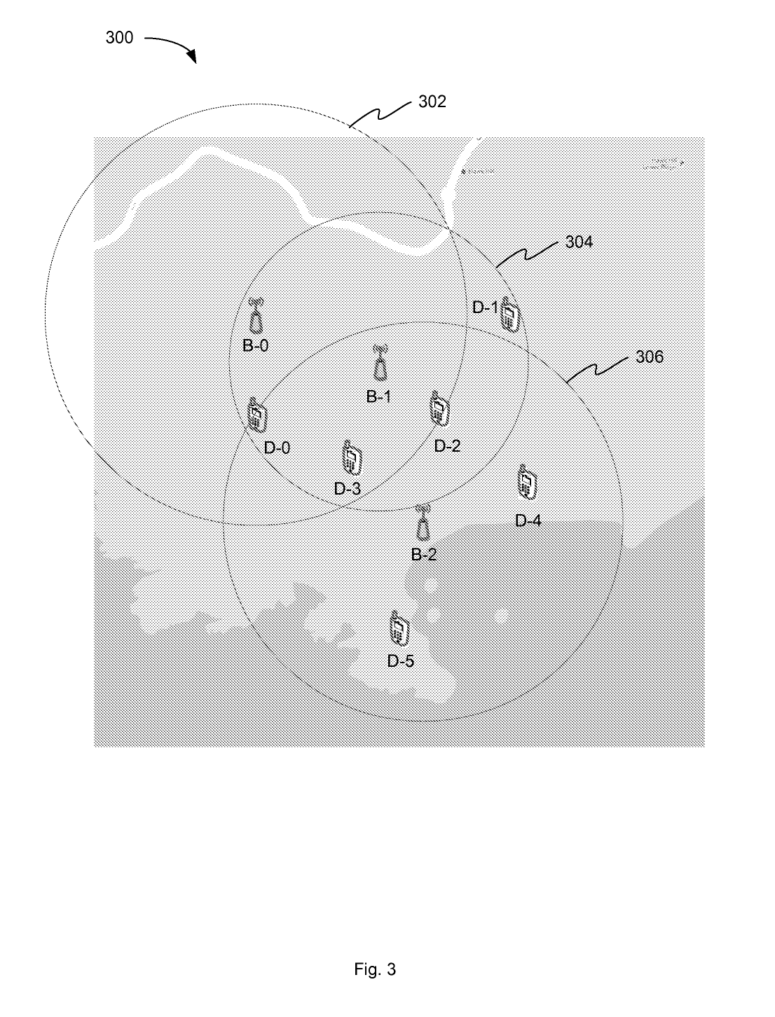

FIG. 3 is a map diagram illustrating a cluster of client devices and the coverage areas of multiple beacons used to determine the proximity of the client devices, according to an embodiment. In one embodiment, the cluster 300 includes client devices D-0, D-1, D-2, D-3, D-4, D-5. These client devices may be representative of client device 110, as shown in FIGS. 1 and 2. In the area where cluster 300 is located there are three detectable beacons B-0, B-1, B2. Each beacon may include, for example, a stationary wireless access point, a mobile wireless access point, a Bluetooth access point, or other signals. For illustration purposes, the signal reach of each beacon is approximated as a circle 302, 304, 306, respectively, with the associated beacon located at the center of the circle. Each client device D-0, D-1, D-2, D-3, D-4, D-5 is assumed to be able to detect or sense the signal from a beacon B-0, B-1, B2 if the device is within the signal reach of that beacon. For example, device D-1 is assumed to be within reach of beacon B-1 alone, devices D-0, D-2, and D-3 are all assumed to be within reach of beacons B-0, B-1, and B-2, and devices D-4 and D-5 are assumed to be within reach of beach B-2 alone. As such, the beacon detectors 210 in each of client devices D-0, D-1, D-2, D-3, D-4, D-5 will detect the above beacons and beacon signature module 222 will include unique identifiers of the above beacons in the corresponding beacon signature.

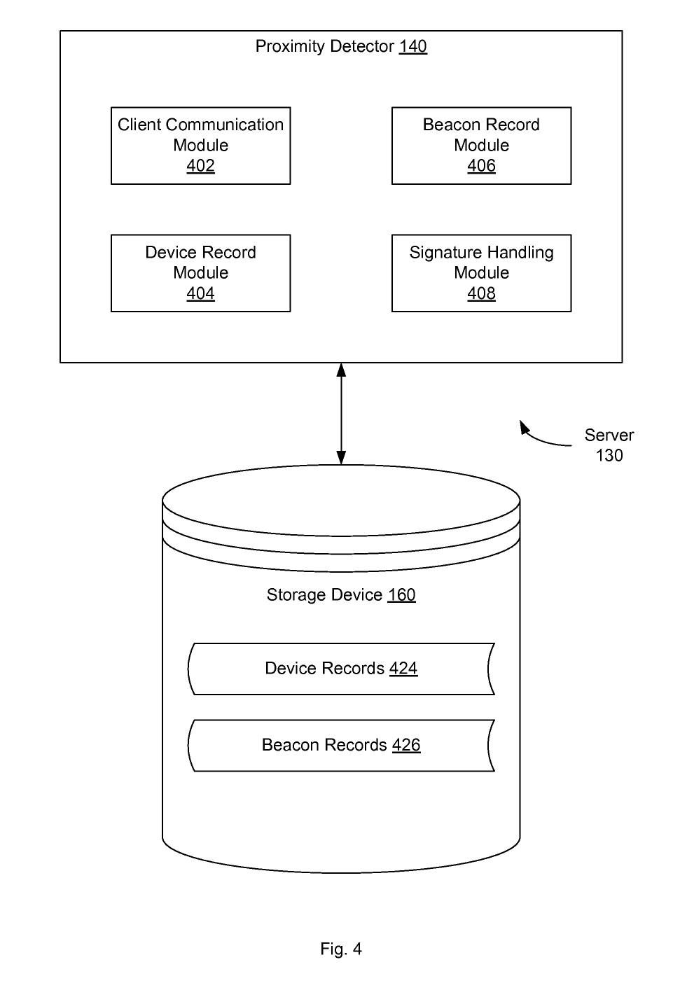

FIG. 4 is a block diagram illustrating a server-side proximity detector, according to an embodiment. In one embodiment, proximity detector 140 includes client communication module 402, device record module 404, beacon record module 406, and signature handling module 408. This arrangement of modules and components may be a logical separation, and in other embodiments, these modules or other components can be combined together or separated in further components, according to a particular implementation. In one embodiment, storage device 160 is connected to proximity detector 140 and includes device records 424 and beacon records 426. In one implementation, server 130 may include both interactive proximity detector and storage device 160. In another embodiment, storage device 160 may be external to server 130, such as part of application server 150, and may be connected to server 130 over a network or other connection. In other implementations, server 130 may include different and/or additional components which are not shown to simplify the description. Data store 160 may include one or more mass storage devices which can include, for example, flash memory, magnetic or optical disks, or tape drives; read-only memory (ROM); random-access memory (RAM); erasable programmable memory (e.g., EPROM and EEPROM); flash memory; or any other type of storage medium.

In one embodiment, client communication module 402 receives beacon signatures from client devices 110. Client communication module 402 may periodically request a beacon signature from the client devices 110 or the client devices may send the beacon signatures according to their own schedule, such as periodically or in response to a change in the beacon signature by beacon signature module 222. In addition, client communication module 402 may send communications to client devices 110. In one embodiment, upon proximity detector 140 determining a proximity of multiple client devices 110, client communication module 402 may provide an indication of the proximity to client devices 110. For example, client communication module 402 generate and provide an ordered list of client devices based on their proximity to a given client device 110 determined in view of a comparison of the received beacon signatures.

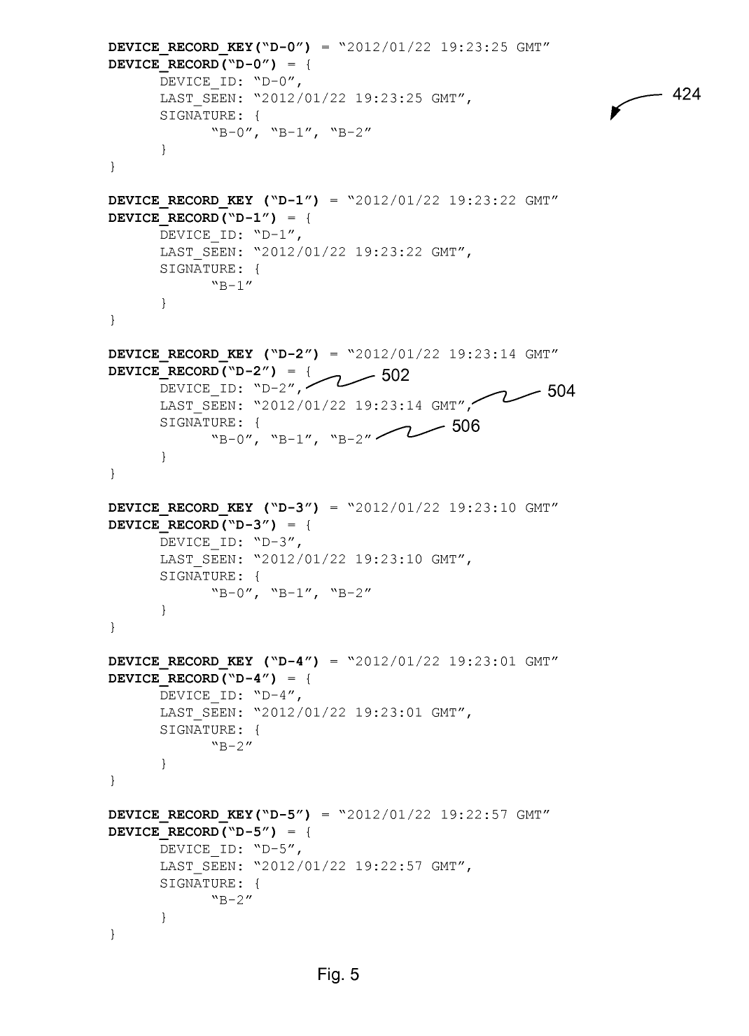

In one embodiment, device record module 404 maintains device records 424 in storage device 160. An example of device records 424 according to one embodiment is shown in FIG. 5. Device records 424 may include a database or other data store with data entries indexed by device, such as client devices 110. In one embodiment, there is a separate data entry for each device 110 that has communicated with proximity detector 140. In one embodiment, upon client communication module 402 receiving information from a client device 110, device record module 404 determines whether a corresponding entry already exists in device records 424. If a corresponding entry exists, device record module 404 updates the data in the entry with the newly received data. If an entry does not already exist, device record module 404 creates a new entry. In one embodiment, each entry in device records 424 includes a device identifier 502, a timestamp 504 indicating when the last device update was received, and a copy of the beacon signature 506 received from the device. In other embodiments, each entry may include additional and/or different information.

In one embodiment, upon client communication module 402 receiving information from a client device 110, device record module 404 may replace the beacon signature received from the device with a smaller signature generated from the first signature by selecting and including a subset of the detected beacons before storing the smaller signature in an entry in device records 424. In one embodiment, the decision of what beacons to select can be made based on an indication of the strength of each beacon, an indication of the beacon type, and/or timestamp indicating when the beacon was detected or last-reported to the server. In one embodiment, device record module 404 may limit the number of beacons in the signature not to exceed a certain maximum.

In some embodiments, including a subset of the detected beacons as part of the smaller beacon signature may disproportionally reduce the number of beacon matches in signatures for devices in proximity to one another. For example, if different subsets of the same set of beacons are selected, it is possible for signatures based on those subsets to have few or no beacons in common.

In some embodiments, for devices in proximity to one another, the expected number of beacon matches in signatures can be increased by having device record module 404 follow a deterministic beacon selection procedure based on intrinsic properties of beacons detected. In one embodiment, device record module 404 can decide what beacons to include as part of the smaller signature in an entry in device records 424 by using a beacon selection procedure based on beacon identifiers.

In one embodiment, device record module 424 can generate the signature from up to a certain maximum of beacons, with preference given to beacons with identifiers that are smaller. In another embodiment, device record module 424 can generate the signature from up to a certain maximum of beacons, with preference given to beacons with identifiers that are larger. In one embodiment, device record module 424 can compute a hash of each beacon identifier and generate the signature from up to a certain maximum of beacons, with preference given to beacons with hashes that are smaller. In another embodiment, device record module 424 can compute a hash of each beacon identifier and generate the signature from up to a certain maximum of beacons, with preference given to beacons with hashes that are larger. In one embodiment, absolute value of the first 8 bytes of MURMUR3_{—}128 hash converted to a Java long type value in little-endian order can be used. In other embodiments, a cryptographically-secure hash function can be used.

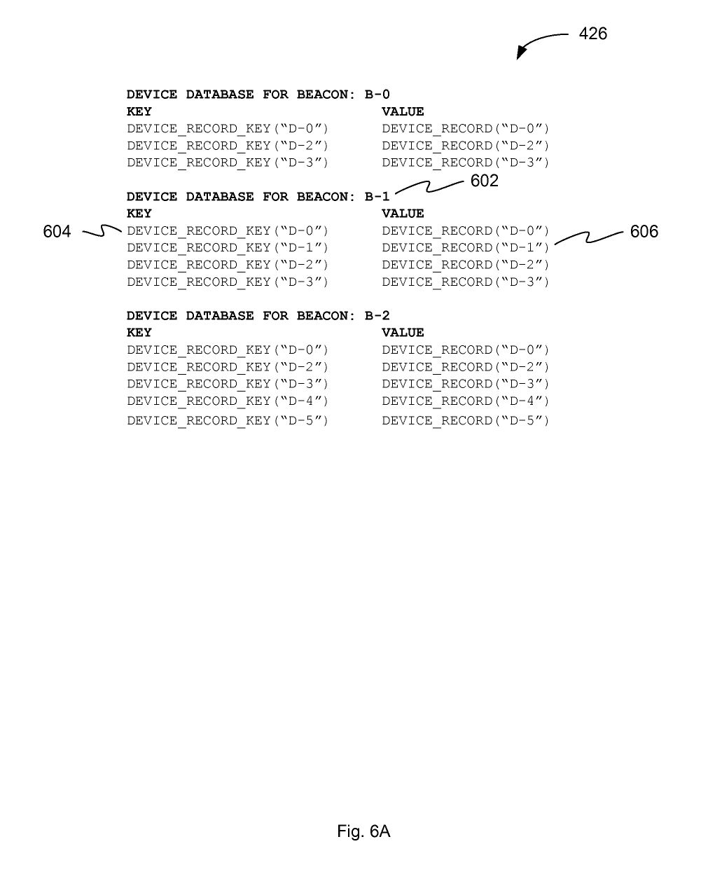

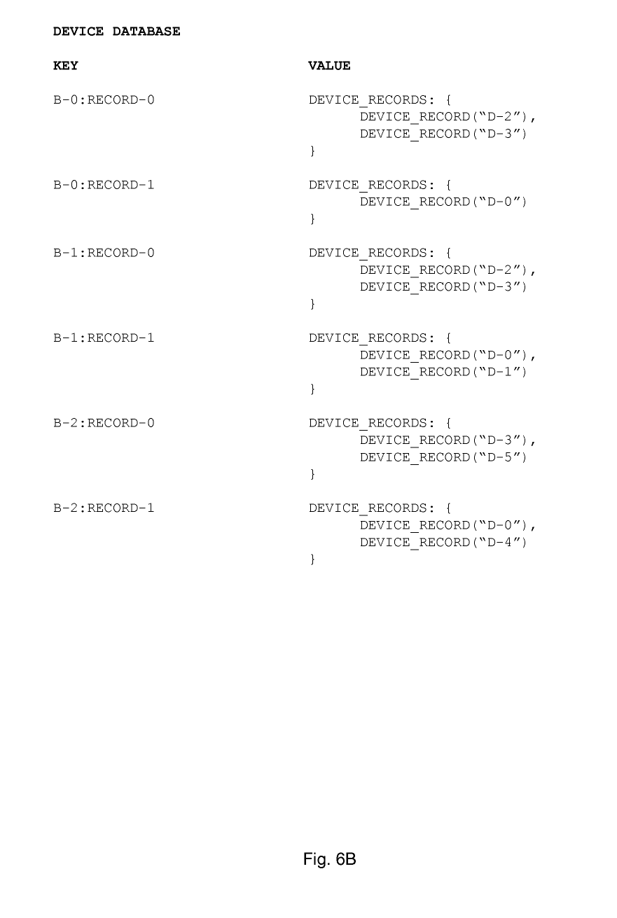

Referring again to FIG. 4, in one embodiment, beacon record module 406 maintains beacon records 426 in storage device 160. Two examples of beacon records 426 are shown in FIGS. 6A and 6B. Beacon records 426 may include a database or other data store with data entries indexed by beacon. In one embodiment, there is a separate data entry for each beacon which has been detected by at least one client device 110. In one embodiment, upon client communication module 402 receiving information from a client device 110 and device record module 404 recording the data in device records 424, beacon record module 406 determines whether a corresponding entry already exists in beacon records 426. If a corresponding entry exists, beacon record module 406 updates the data in the entry with the newly received data (i.e., an indication of which client devices 110 detected a particular beacon). If an entry does not already exist, beacon record module 406 creates a new entry. In one embodiment, each entry in beacon records 426 includes a beacon identifier 602, and a set of key-value pairs. The key may be a device record key 604 indicating an entry in device records 424 for a given device and the value may be the device record itself 606 which identifies the given device. In other embodiments, each entry may include additional and/or different information.

In one embodiment, proximity detector 140 can operate without an explicit device record module 404 or device records 424. In this embodiment, all the device update information, including beacon signatures, is stored in entries in beacon records 426. In this embodiment, because each device is generally associated with multiple beacons, device information is replicated and stored in multiple entries, one for each beacon in the beacon signature. Since each copy of the device information is relatively small in size, the device records can be maintained as part of beacon records 426, rather than in a separate storage that would also require an extra level of indirection to retrieve device data.

In one embodiment, upon client communication module 402 receiving information from a client device 110 and device record module 404 recording the data in device records 424, beacon record module 406 may update entries in beacon records 426 for a subset of beacons in the beacon signature. In one embodiment, the decision what beacons to select can be made based on an indication of strength of each beacon, an indication of the beacon type, and/or timestamp indicating when the beacon was detected or last-reported to the server. In one embodiment, beacon record module 406 may limit the number of entries to update in beacon records 426 not to exceed a certain maximum.

FIG. 6B illustrates an alternative layout of beacon records 426 associated with beacons B-0, B-1, and B-2 in FIG. 3 as a single database with device records as defined in FIG. 5. Instead of maintaining a separate database for each beacon, a single database possibly distributed across a plurality of networked computers can be used, with parts of the database used to store records of devices associated with each beacon. Records of devices associated with each beacon may be distributed across a plurality of beacon records 426 using a hash function that maps each device as defined using a unique device ID to a beacon record as defined using an ID of the beacon record. In one embodiment, each beacon record in the database maintains a subset of records of devices associated with the beacon and is stored in the database indexed using a key comprising the unique ID of the beacon followed by the ID of the beacon record. The purpose of distributing device records associated with the same beacon across a plurality of beacon records is to limit the cost of adding, removing, or updating a single device record to that of updating a single beacon record with a limited number of device records in it. For illustration purposes, the hash function that maps each device ID to an ID of the beacon record is defined as following:

HASH(“D-0”)=RECORD-1

HASH(“D-1”)=RECORD-1

HASH(“D-2”)=RECORD-0

HASH(“D-3”)=RECORD-0

HASH(“D-4”)=RECORD-1

HASH(“D-5”)=RECORD-0

Because geographic coordinates of each client device are expected to change with time, so is the device signature. For proximity estimates to remain accurate with time, the system can provide a mechanism to disassociate any device with beacons that are no longer part of the device signature. In some embodiments, a timestamp of the last time a client device was associated with a beacon can be maintained. In general, the interval between any two consecutive updates from the client device is expected to be smaller than a period of time represented by time threshold. This way, as long as the client device has an active beacon and is capable of sending updates, the device record for the beacon, including the last-updated timestamp, is updated regularly to prevent the device record from expiring (e.g., by the passage of time threshold) and getting deleted. Thus, it is unlikely that a device has an active beacon after the time threshold expires, because the client device would have updated the server before the threshold. Therefore, devices with a timestamp older than the time threshold can be removed from the beacon database once the timestamp becomes older the time threshold. In another embodiment, each client may explicitly request the server to remove it from the beacon database once the beacon is no longer active. In the event that the client is unable to send removal requests either due to a connectivity problem or because the client is down (user shut down the device, the battery ran out, etc.), the expiration mechanism described above (i.e., time threshold) can remove the client device and prevent it from appearing in search results when it should not.

In some embodiments, the system can opportunistically delete records of devices last-associated with a beacon more than some time threshold prior as part of a write operation to the beacon database. In some embodiments, each device can explicitly instruct the system to remove the device from a plurality of beacon databases that no longer match the new beacon signature of the device.

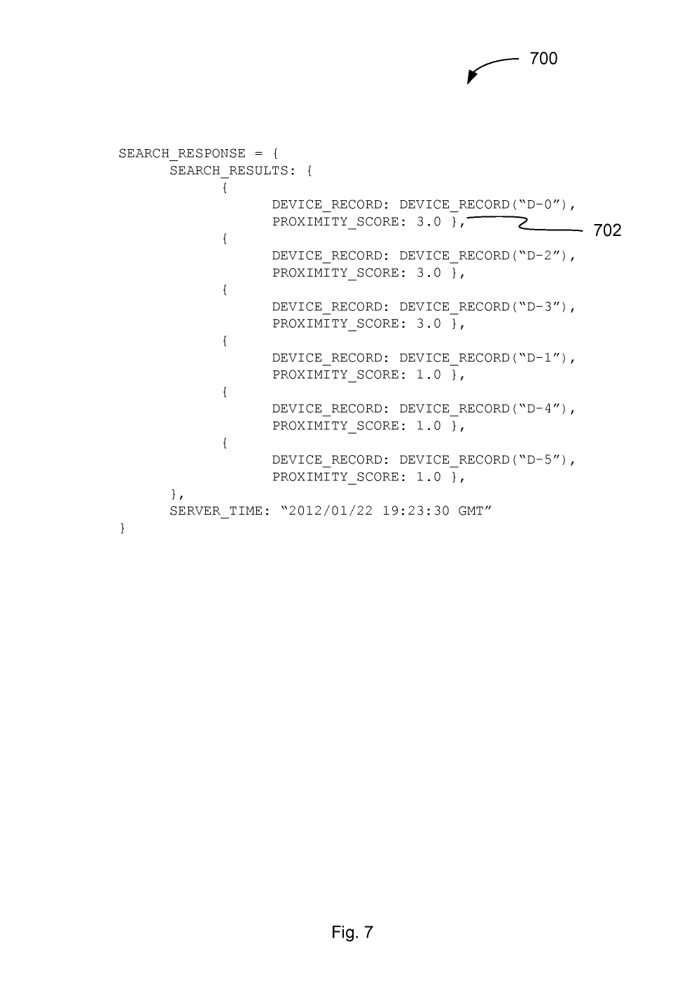

Referring again to FIG. 4, signature handling module 408 makes a determination of proximity between multiple client devices. In one embodiment, signature handling module 408 receives an indication of the beacons represented in the device signature of a first client device from device record module. Signature handling module 408 also receives an indication of each other client device that is also associated with one of those beacons from beacon record module 406. Signature handling module 408 receives the beacon signatures from each of those other client devices from device record module 404 and compares the beacon signature of the first client device to each of the other receives beacon signatures. In one embodiment, signature handling module determines a number of beacons that are shared between any two beacon signatures and uses that number as a measure of proximity of the corresponding client devices 110 (e.g., the higher the number of shared beacons, the closer the devices are to one another). FIG. 7 illustrates the results 700 of a comparison of beacon signatures for determining device proximity according to one embodiment. The illustrated search results 700 show a textual representation of a proximity-search response for client device D-2 in FIG. 3. For illustration purposes, the number of Wi-Fi beacons that a device and the origin have in common between their respective signatures is used as the measure of proximity between the device and the origin. The resulting number is shown as the proximity score 702 for each device. In one embodiment, the beacon signatures for devices D-2, D-0 and D-3 each have three beacons in common. Thus, the proximity score 702 for these devices is “3.0.” The beacon signature for device D-2 has one beacon in common with each of devices D-1, D-4 and D-5. Thus, the proximity score 702 for these devices is “1.0.”

In one embodiment, signature handling module 408 determines a subset of the other client devices for which the beacon signatures satisfy a proximity threshold with respect to the beacon signature of the first client device. For example, the proximity threshold may specify a minimum number of beacons (e.g., two beacons, three beacons or some other number of beacons) that should be shared between the beacon signatures. In one embodiment, signature handling module 408 generates an ordered list of the subset of client devices that satisfy the proximity threshold based on the proximity of the devices to the first client device (i.e., the number of beacons shared between the beacon signatures). Signature handling module 408 may provide the ordered list to client communication module 402, which may provide the ordered list to the first client device 110.

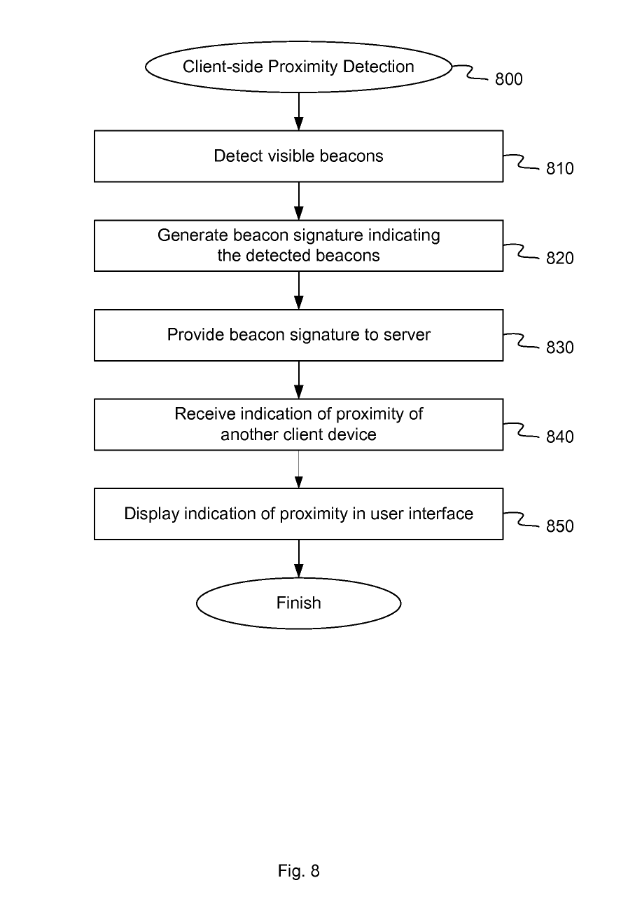

FIG. 8 is a flow diagram illustrating method for client-side proximity detection, according to an embodiment. The method 800 may be performed by processing logic that comprises hardware (e.g., circuitry, dedicated logic, programmable logic, microcode, etc.), software (e.g., instructions run on a processing device to perform hardware simulation), or a combination thereof. The processing logic is configured to generate a beacon signature based on the detected signal beacons, provide the beacon signature to a server, and receive an indication of proximity of other client devices determined in view of the beacon signature. In one embodiment, method 800 may be performed by client device 110, as shown in FIGS. 1 and 2.

Referring to FIG. 8, at block 810, method 800 detects a plurality of visible beacons. In one embodiment, beacon detector 210 detects beacons that are “visible” to the client device 110. The beacons can include, for example, signals from Wi-Fi access points, such as stationary or mobile wireless access points, Bluetooth signals from other wireless devices, or other signals. A beacon may be “visible” to client device 110 when client device 110 is within range of the beacon and beacon detector 210 is able to detect the presence of the signal. Beacon detector 210 may also determine the signal strength of a detected beacon and the type of beacon detected (e.g., stationary or mobile wireless access point, Bluetooth signal, etc.).

At block 820, method 800 generates a first beacon signature indicating the plurality of beacons detected at block 810. In one embodiment, beacon signature module 222 generates a beacon signature indicating the beacons detected by beacon detector 210. In one embodiment, the beacon signature includes a list, concatenation, or other format including the unique identifier of each beacon detected by beacon detector 210. In other embodiments, the beacon signature additionally includes an indication of the signal strength of each detected beacon, an indication of the beacon type and/or a timestamp indicating when the beacon was detected. In one embodiment, beacon signature module 222 generates a new or updates a previous beacon signature periodically or in response to a change in the beacons detected by beacon detector 210.

At block 830, method 800 provides the first beacon signature to a server. In one embodiment, server communication module 224 provides the beacon signatures generated by beacon signature module 222 to server 130. Server communication module 224 may send the beacon signature to server 130 periodically, in response to a request from server 130, or in response to a change in the beacon signature by beacon signature module 222.

At block 840, method 800 receives, from the server, an indication of a proximity of a second client device to the first client device. In one embodiment, the proximity is determined in view of the first beacon signature and a second beacon signature from the second client device. In one embodiment, server communication module 224 may receive an indication of one or more other client devices that are in proximity to the client device 110. The indication may include an ordered list of other client devices arranged based on their proximity to the client device 110. In one embodiment, server 130 may determine the proximity based on a comparison of the beacon signatures from the various client devices 110. The higher the number of beacons that are shared between two beacon signatures, the closer in proximity the associated client devices 110 are to one another.

At block 850, method 800 displays an indication of the proximity of the client devices in a user interface. In one embodiment, user interface module 226 presents a user interface (e.g., on a display of client device 110) to provide the proximity information received by server communication module 224 from server 130. In one embodiment, user interface module 226 may display the ordered list of client devices received from server 130. In addition to the client devices, user interface module 226 may display profile information for a user corresponding to each of the client devices.

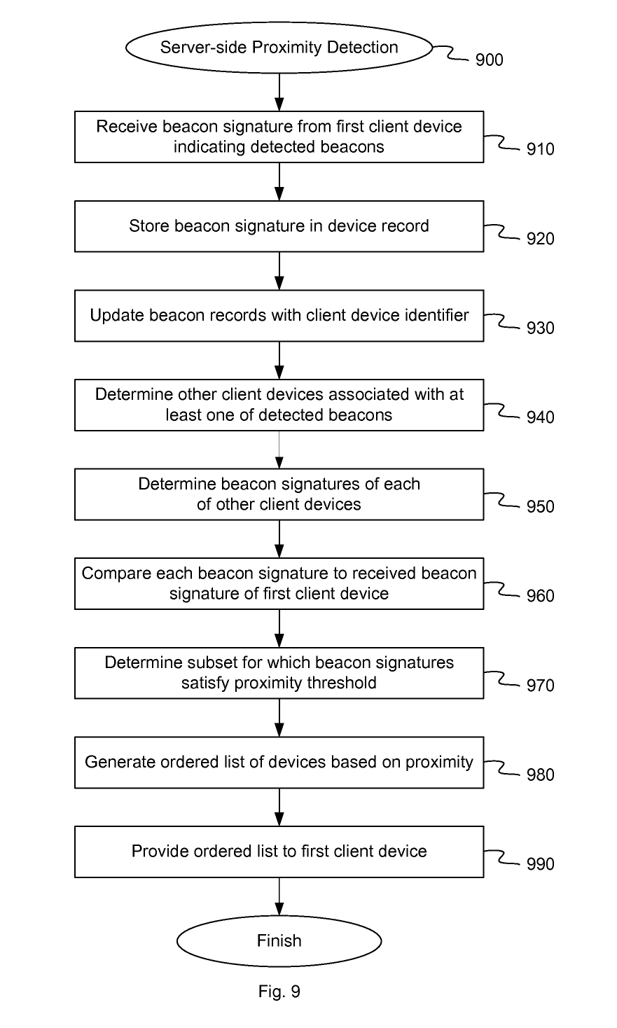

FIG. 9 is a flow diagram illustrating method for server-side proximity detection, according to an embodiment. The method 900 may be performed by processing logic that comprises hardware (e.g., circuitry, dedicated logic, programmable logic, microcode, etc.), software (e.g., instructions run on a processing device to perform hardware simulation), or a combination thereof. The processing logic is configured to receive beacon signature from client devices and determine the proximity of other client devices in view of the received beacon signatures. In one embodiment, method 900 may be performed by proximity detector 140, as shown in FIGS. 1 and 4.

Referring to FIG. 9, at block 910, method 900 receives a first beacon signature from a first client device indicating a plurality of beacons detected by the first client device. In one embodiment, client communication module 402 receives beacon signatures from client devices 110. Any client device 110 which is used as the origin, may be referred to as “the origin device.” Client communication module 402 may periodically request a beacon signature from the client devices 110 or the client devices may send the beacon signatures according to their own schedule, such as periodically or in response to a change in the beacon signature by beacon signature module 222.

At block 920, method 900 stores the first beacon signature in a device record corresponding to the first client device. In one embodiment, device record module 404 maintains device records 424 in storage device 160. Device records 424 may include a database or other data store with data entries indexed by device, such as client devices 110. In one embodiment, upon client communication module 402 receiving information from a client device 110, device record module 404 determines whether a corresponding entry already exists in device records 424. If a corresponding entry exists, device record module 404 updates the data in the entry with the newly received data. If an entry does not already exist, device record module 404 creates a new entry.

At block 930, method 900 updates a beacon record corresponding to each of the detected beacons to include an indication of the first client device. In one embodiment, beacon record module 406 maintains beacon records 426 in storage device 160. Beacon records 426 may include a database or other data store with data entries indexed by beacon. In one embodiment, upon client communication module 402 receiving information from a client device 110, and device record module 404 recording the data in device records 424, beacon record module 406 determines whether a corresponding entry already exists in beacon records 426. If a corresponding entry exists, beacon record module 406 updates the data in the entry with the newly received data (i.e., an indication of which client devices 110 detected a particular beacon). If an entry does not already exist, beacon record module 406 creates a new entry.

At block 940, method 900 determines other client devices that are also associated with at least one of the beacons in the first beacon signature. In one embodiment, signature handling module 408 receives an indication of the beacons represented in the device signature of a first client device from device record module 404. Signature handling module 408 also receives an indication of each other client device that is also associated with one of those beacons from beacon record module 406.

At block 950, method 900 determines the beacon signatures of each of the other client devices. In one embodiment, signature handling module 408 receives the beacon signatures from each of those other client devices from device record module 404.

At block 960, method 900 compares the beacon signature of each of the other client devices to the first beacon signature of the first client device. In one embodiment, signature handling module 408, compares the beacon signature of the first client device to each of the other receives beacon signatures. In one embodiment, signature handling module 408 determines a number of beacons that are shared between any two beacon signatures and uses that number as a measure of proximity of the corresponding client devices 110 (e.g., the higher the number of shared beacons, the closer the devices are to one another).

At block 970, method 900 determines a subset of the other client devices for which the beacon signatures satisfy a proximity threshold with respect to the first beacon signature. In one embodiment, signature handling module 408 determines a subset of the other client devices for which the beacon signatures satisfy a proximity threshold with respect to the beacon signature of the first client device. For example, the proximity threshold may specify a minimum number of beacons (e.g., two beacons, three beacons or some other number of beacons) that should be shared between the beacon signatures.

At block 980, method 900 generates an ordered list of the subset of other client devices based on the proximity to the first client device. In one embodiment, signature handling module 408 generates an ordered list of the subset of client devices that satisfy the proximity threshold based on the proximity of the devices to the first client device (i.e., the number of beacons shared between the beacon signatures).

At block 990, method 900 provides the ordered list to the first client device. In addition, client communication module 402 may send communications to client devices 110. In one embodiment, upon proximity detector 140 determining a proximity of multiple client devices 110, client communication module 402 may provide an indication of the proximity to client devices 110. For example, client communication module 402 may provide the ordered list of client devices based on their proximity to a given client device 110 determined in view of a comparison of the received beacon signatures.

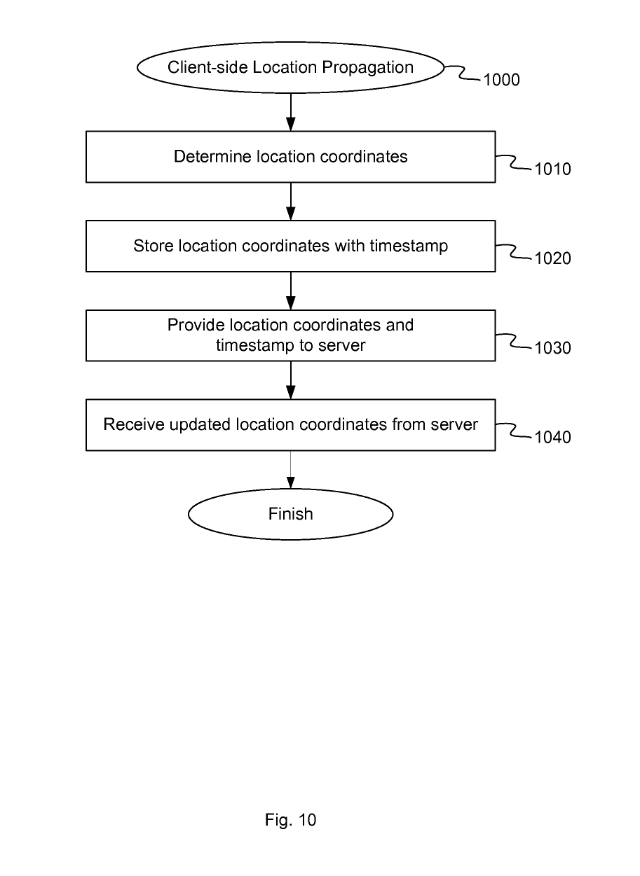

FIG. 10 is a flow diagram illustrating method for client-side location propagation, according to an embodiment. The method 1000 may be performed by processing logic that comprises hardware (e.g., circuitry, dedicated logic, programmable logic, microcode, etc.), software (e.g., instructions run on a processing device to perform hardware simulation), or a combination thereof. The processing logic is configured to determine location coordinates, provide them to a server and receive updated location coordinates, if available. In one embodiment, method 1000 may be performed by client device 110, as shown in FIGS. 1 and 2.

Referring to FIG. 10, at block 1010, method 1000 determines first location coordinates of the client device. In one embodiment, location coordinate circuit 230 determines location coordinates of the client device 110. Location coordinate circuit 230 may determine the location coordinates in a number of ways including, for example, using the Global Positioning System (GPS), cellular triangulation using the location of known cellular network towers, Wi-Fi triangulation using the location of known stationary Wi-Fi access points, or other techniques. In some embodiments, location coordinate circuit 230 may only be activated to determine the location coordinates periodically (e.g., every 30 minutes) or in response to a specific request from the user or another application.

At block 1020, method 1000 stores the first location coordinates with a timestamp. In one embodiment, client device 110 includes a storage device where the location coordinates can be stored. The timestamp indicates the time and date when the first location coordinates were determined by location coordinate circuit 230.

At block 1030, method 1000 provides the first location coordinates and the timestamp to the server. In one embodiment, server communication module 224 in proximity application 120 obtains the first location coordinates and the timestamp from the location in storage and transmits the data to server 130. In one embodiment, server communication module 224 performs this operation periodically, in response to new location coordinates being obtained, or in response to a request from server 130.

At block 1040, method 1000 receives updated location coordinates associated with a second client device that is in proximity to the first client device. In one embodiment, the updated location coordinates are determined from a second client device that is in proximity to the first client device. In one embodiment, the updated location coordinates were obtained more recently than the first location coordinates, as demonstrated by the associated timestamps. The updated location coordinates are assumed to be accurate with respect to the first client device, since the second client device is within a certain proximity of the first client device. The first client device can use the location specified by the updated location coordinates as its current location with respect to any location-based services.

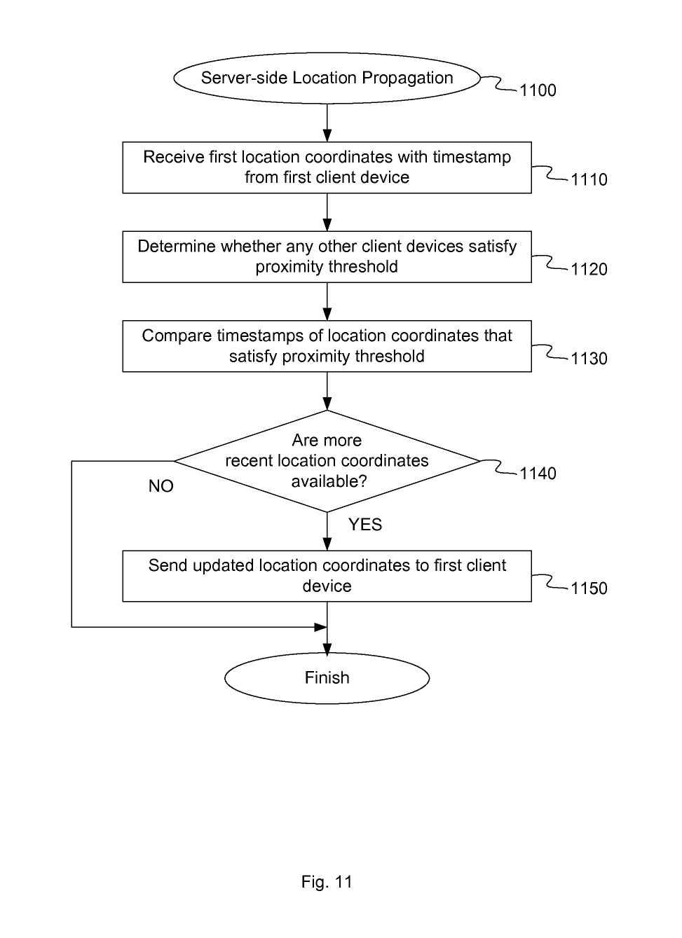

FIG. 11 is a flow diagram illustrating method for server-side location propagation, according to an embodiment. The method 1100 may be performed by processing logic that comprises hardware (e.g., circuitry, dedicated logic, programmable logic, microcode, etc.), software (e.g., instructions run on a processing device to perform hardware simulation), or a combination thereof. The processing logic is configured to receive location coordinates from a first client device and provide updated location coordinates from another device in proximity to the first client device. In one embodiment, method 1100 may be performed by proximity detector 140, as shown in FIGS. 1 and 4.

Referring to FIG. 11, at block 1110, method 1100 receives first location coordinates with a timestamp from a first client device. In one embodiment, client communication module 402 receives location coordinates from client devices 110. Client communication module 402 may periodically request location coordinates from the client devices 110 or the client devices may send the location coordinates according to their own schedule, such as periodically or in response to a change in the location coordinates as determined by location coordinate circuit 230.

At block 1120, method 1100 determines whether any other client devices satisfy a proximity threshold with respect to the first client device. In one embodiment, signature handling module 408 determines the proximity of other client devices according to method 900, described above with respect to FIG. 9. Signature handling module 408 compares the beacon signatures of various client devices to determine the number of shared beacons. If the number of shared beacons satisfies the proximity threshold (e.g., three shared beacons), then the client devices are considered to be within sufficient proximity to share location coordinates. In other embodiments, proximity detector 140 determines the proximity of client devices using techniques besides the beacon signature method described herein.

At block 1130, method 1100 compares the timestamps of location coordinates from devices that satisfy the proximity threshold to the timestamp of the first location coordinates from the first client device. In one embodiment, proximity detector 140 compares the timestamps to one another.

At block 1140, method 1100 determines whether the location coordinates from another client device were obtained more recently that the first location coordinates using the timestamps. Proximity detector 140 locates timestamps from the other client devices in proximity to the first client device that were obtained more recently than the location coordinates from the first client device. If a second client device is in proximity to the first client device and obtained location coordinates more recently than the first client device, it is likely that the second location coordinates from the second client device are more accurate with respect to the current location of the first and second client devices than the first location coordinates.

If there are more recent location coordinates available, at block 1150, method 1100 provides the updated location coordinates from the other client device to the first client device. In one embodiment, client communication module 402 may provide the updated location coordinates to the first client devices. In other embodiments, rather than providing all of the location coordinates from the second client device to the first client device, proximity detector 140 may compute a weighted average of the original first coordinates and one or more sets of second device coordinates. Factors that can be taken into account to compute the weighting may include, for example, when the coordinates were captured, how the coordinates were obtained (e.g., GPS, Wi-Fi triangulation), or other factors.

In some embodiments, the system can be used to identify client computer devices in proximity to the last-known geographical location of a client computer device, using the last-known state of the device, including geographical coordinates and/or the beacon signature of the device.

In some embodiments, the system can be used to identify client computer devices in proximity to a past geographical location of a client computer device, using a pre-recorded state of the device from that moment. For example, by saving the state of their device while at a restaurant, a user can later use the recorded state to identify client devices in proximity to the restaurant without being next to (or within) the restaurant themselves or having their device be in proximity to the restaurant.

In some embodiments, pre-recorded states can be associated with geographical locations and/or known geographical entities and shared between client devices.

In some embodiments, each user can be limited in terms of the number of pre-recorded device states they can use to reduce the likelihood of abuse, such as tracking movements of other users.

In some embodiments, to prevent a user from lying about the last-known state of their device, such as using a pre-recorded state, as opposed to the last-known state of the device, the system can require that any device found in proximity to the geographical location of the origin device, as assumed from the origin-device state received as part of a proximity-search request, has a beacon signature sufficiently similar to that of the origin device. For example, in one embodiment, a computer device can be excluded from proximity-search results if it shares less than fraction BT (beacon threshold) of beacons with the origin. This technique assumes that a beacon signature associated with any particular geographical location changes with time due to new beacons popping up, existing beacons shutting down, or some beacons such as “portable” Wi-Fi access points in modern smartphones changing their location with time. Proximity-search requests based on pre-recorded device states that count towards a user recorded-state limit can be exempt from the minimum-similarity requirement in certain embodiments.

In some embodiments, the system can be used to identify client devices in proximity to a given origin and associating a plurality of entities with these client devices. A plurality of entities can be associated with each client device and a plurality of client devices can be associated with each entity. An entity may be, for example, an individual user of a particular client device.

In some embodiments, a plurality of user accounts can be associated with each client device and a plurality of client devices can be associated with each user account.

In some embodiments, each user account can have a plurality of user profiles, with each user profile representing a collection of semi-structured data that the user chooses to share about themselves. The data may include for example, name, address, phone number, email address, age, occupation, nationality, photos of the user, etc. The user can activate a profile on a device either explicitly or on a particular schedule. For example, a user may have a business profile active on their smartphone during work hours and a dating profile activated by default after 9 pm. Thus, depending on which profile is activated at a given time, different information may be made available when a client device is discovered by the server using one of the techniques described herein.

In some embodiments, the system can be used to identify users in proximity to each other by means of identifying computer devices in proximity to each other and identifying user profiles associated with said computer devices. If the system determines that two or more devices are in proximity to each other, the system can identify users associated with the devices (e.g., by consulting the corresponding user profiles) and determine that those users are in proximity to each other as well.

In some embodiments, the system can identify two or more users in proximity to each other and establish a communication channel between a subset of identified users. For example, once a first user identifies other users in proximity to themselves, the first user can connect with other users nearby by means of text, video, and/or other media.

In some embodiments, the system can establish a direct communication channel between two users by using a peer-to-peer (P2P) communication facility such as Wi-Fi Direct.

In some embodiments, the system can establish a communication channel between a subset of users in the system by using a push notification facility such as Google Cloud Messaging (GCM) or Android Cloud to Device Messaging (C2DM) service.

One embodiment enables a user of the system to identify other users nearby and identify user profiles of the other users. This embodiment enables the user to browse profiles of users nearby, filter user profiles by properties such as sex and age, and to connect with users by means of text, video, and/or other media.

This embodiment is based on client-server architecture as shown in FIG. 1. Each client computer has a version of a client application computer program installed. Different versions of the program are installed on different types of computer devices such as iOS and Android.

When a user installs the client application program on a computer device, they either create a new user account or log into a previously-created user account. When the user logs in, they either create a new user profile or activate one of possibly multiple previously-created user profiles. User account information, including user profiles, is synchronized between the client and the server. If the user edits their account information using an instance of the client application program on a client device, all changes to the user account are propagated to the server and from there to other client devices associated with the same user.

This embodiment identifies computer devices in proximity to each other, using a combination of the coordinate-based (tile-based) and beacon-based methods. On the client side, the client application program runs a background service that periodically (or in response to a user request) identifies the last-known geographical coordinates and the Wi-Fi beacon signature of the device and sends that information along with information about the currently active user profile as part of a device-update request to the server. Wi-Fi BSSIDs are used to uniquely identify each Wi-Fi beacon in the device signature. On Android devices, the last-known geographical coordinates and the Wi-Fi beacon signature of a device can be obtained via LocationManager and WifiManager classes available as part of Android SDK. In one embodiment, AlarmManager class, also available as part of the SDK, can be used to schedule repeating device-update requests, even when the client application program is not running. In another embodiment, the client application program can request current geographical coordinates from the client computer device and send those coordinates to the server.

To limit the number of update requests, the client may not send an update to the server unless the last-known geographical location or the Wi-Fi signature of the device has changed significantly since the last update, or unless the device record from the last update on the server is about to expire. For example, the client may compare the distance between the last-known geographical location and the location from the last update to a distance threshold. If the distance is less than the distance threshold, the client may not send an update to the server.

For client devices that support “portable” Wi-Fi access-point functionality, if the number of beacons that a device can sense is smaller than threshold AN, the client application program activates the Wi-Fi access-point beacon of the device to improve the ability of the system to estimate relative proximity of devices that can sense the beacon. If the number of beacons that the device can sense is larger than threshold DN, the client application program shuts down the Wi-Fi access-point beacon of the device, provided that the access-point was originally activated by the client application program and not the user.

On the server side, two distributed in-memory device databases based on Memcached are maintained: a beacon-indexed device database used to store device records associated with known Wi-Fi beacons, and a tile-indexed device database used to store device records associated with tiles on a rectangular spatial grid, with tiles based on Geohash, MDRS, or similar methodology.

In the beacon-based device database, records of devices associated with each beacon are distributed across a plurality of beacon records using a hash function that maps each device as defined using a unique device ID to a beacon record as defined using an ID of the beacon record. Each beacon record in the database maintains a subset of records of devices associated with the beacon and is stored in the database indexed using a key comprising the unique ID of the beacon followed by the ID of the beacon record. Every time a beacon record in the database is updated, expired records of devices last-associated with the beacon more than time threshold ET prior are opportunistically deleted from the beacon record.

The number of beacon records stored in the database for a beacon is changed dynamically with the number of devices associated with the beacon to keep the number of device records in any beacon record below a certain maximum threshold BDM. When the number of beacon records for the same the beacon is changed, records stale due to re-hashing are deleted opportunistically. A consistent hashing algorithm is used to minimize the number of stale records due to re-hashing.

In the tile-indexed device database, records of devices associated with each tile are distributed across a plurality of tile records using a hash function that maps each device as defined using a unique device ID to a tile record as defined using an ID of the tile record. Each tile record in the database maintains a subset of records of devices associated with the tile and is stored in the database indexed using a key comprising the unique ID of the tile followed by the ID of the tile record. Every time a tile record in the database is updated, expired records of devices last-associated with the tile more than time threshold T prior are opportunistically deleted from the tile record.

The number of tile records stored in the database for a tile is changed dynamically with the number of devices associated with the tile to keep the number of device records in any tile record below a certain maximum threshold CDM. When the number of tile records for the same the tile is changed, records stale due to re-hashing are deleted opportunistically. A consistent hashing algorithm is used to minimize the number of stale records due to re-hashing.

When a device-update request is received by an application server, the server authenticates the request and parses the device record. Based on the Wi-Fi signature of the device, copies of the device record are written to the beacon-indexed device database for each beacon in the device signature. Based on the device geographic coordinates, copies of the device record are written to the tile-indexed device database for the tile on the spatial grid that the device belongs to as well as tiles adjacent to the tile on the grid.

On the client side, when the client application program on a device runs in the foreground, the program starts a background service that periodically sends proximity-search requests to the server for an up-to-date list of users associated with computer devices in proximity to the device. Similar to device-update requests, each proximity-search request includes the last-known geographical coordinates and the Wi-Fi beacon signature of the device.

On the server side, when a proximity-search request is received by an application server, the server authenticates the request and parses the last-known geographical coordinates and the Wi-Fi beacon signature of the origin device. For each beacon in the device signature, device records associated with the beacon are retrieved from the beacon-indexed device database. Wi-Fi signatures of said devices are compared to that of the origin device, and devices are sorted according to their perceived proximity to the origin. If the number of results is above threshold RN, device records are sent to the client as part of a proximity-search response.

If the number of results obtained using the beacon-based method is below threshold RN, the server falls back to the geographic-coordinate (tile-based) method. Based on the geographic coordinates of the origin device, the device is mapped to a tile on the spatial grid and device records associated with the tile and tiles adjacent to said tile on the grid are retrieved from the tile-indexed device database. Geographic coordinates of devices retrieved are compared to those of the origin, and devices are sorted according to their perceived proximity to the origin. Then, a combination of device records obtained using beacon- and tile-based methods are sent to the client.

On the client side, the client application program displays proximity-search results by displaying images of users associated with computer devices in proximity to the client device as well as other information, such as the last time each user in the search results was detected in proximity to the client device (i.e., the time of the last device update received by the server). For each user profile in the search results, a separate request is sent to retrieve the image associated with the user profile as well as other user profile information from the server. If the user selects a search result, the client application program fetches and displays more-detailed information about the user profile in question.

FIG. 12 illustrates a diagrammatic representation of a machine in the exemplary form of a computer system 1200 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 1200 may be representative of a computing device, such as client device 110 or server 130, running proximity detector 140.

The exemplary computer system 1200 includes a processing device 1202, a main memory 1204 (e.g., read-only memory (ROM), flash memory, dynamic random access memory (DRAM) (such as synchronous DRAM (SDRAM) or Rambus DRAM (RDRAM), etc.), a static memory 1206 (e.g., flash memory, static random access memory (SRAM), etc.), and a data storage device 1218, which communicate with each other via a bus 1230. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 1202 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1202 may also be one or more special-purpose processing devices such as an application specific integrated circuit (ASIC), a field programmable gate array (FPGA), a digital signal processor (DSP), network processor, or the like. The processing device 1202 is configured to execute processing logic 1226 for performing the operations and steps discussed herein.

The computer system 1200 may further include a network interface device 1208. The computer system 1200 also may include a video display unit 1210 (e.g., a liquid crystal display (LCD) or a cathode ray tube (CRT)), an alphanumeric input device 1212 (e.g., a keyboard), a cursor control device 1214 (e.g., a mouse), and a signal generation device 1216 (e.g., a speaker).

The data storage device 1218 may include a machine-accessible storage medium 1228, on which is stored one or more set of instructions 1222 (e.g., software) embodying any one or more of the methodologies of functions described herein. The instructions 1222 may also reside, completely or at least partially, within the main memory 1204 and/or within the processing device 1202 during execution thereof by the computer system 1200; the main memory 1204 and the processing device 1202 also constituting machine-accessible storage media. The instructions 1222 may further be transmitted or received over a network 1220 via the network interface device 1208.

The machine-readable storage medium 1228 may also be used to store instructions for identifying computer devices in proximity to a given origin, as described herein. While the machine-readable storage medium 1228 is shown in an exemplary embodiment to be a single medium, the term “machine-readable storage medium” should be taken to include a single medium or multiple media (e.g., a centralized or distributed database, and/or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

1. A method comprising:
receiving a first beacon signature from a first client device, the first beacon signature indicating a plurality of beacons detected by the first client device;
determining a second beacon signature associated with a second client device, wherein the second client device is associated with at least one of the plurality of beacons detected by the first client device;
comparing, by a processing device, the first beacon signature to the second beacon signature; and
determining a proximity of the first client device and the second client device in view of the comparing of the first beacon signature and the second beacon signature.

2. The method of claim 1, wherein the first beacon signature comprises an identifier for each of the plurality of beacons detected by the first client device and an indication of a detected beacon strength for each of the plurality of beacons.

3. The method of claim 1, further comprising:
storing the first beacon signature in a device record associated with the first client device; and
updating a beacon record corresponding to each of the plurality of beacons detected by the first client device to include an indication of the first client device.

4. The method of claim 1, further comprising:
determining a plurality of other client devices that are associated with at least one of the plurality of beacons detected by the first client device;
determining beacon signatures for each of the plurality of other client devices;
comparing the beacon signatures for each of the plurality of other client devices to the first beacon signature; and
determining a subset of the plurality of other client devices for which the beacon signatures satisfy a proximity threshold with respect to the first beacon signature.

5. The method of claim 4, further comprising:
generating an ordered list of the subset of the plurality of other client devices based on a proximity of the subset of the plurality of other client devices to the first client device; and
providing the ordered list to the first client device.

6. The method of claim 5, wherein generating the ordered list comprises determining a relative proximity of each of the subset of the plurality of other client devices to the first client device based on a number of beacons present in both the first beacon signature and beacon signatures corresponding to the other client devices, wherein the beacons are weighted with beacon weighting values determined using a historical degree of agreement for the beacons, and wherein a beacon weighting value is inversely proportional to a strength of a corresponding beacon.

7. The method of claim 1, further comprising:
receiving first location coordinates with a first associated timestamp from the first client device;
determining that the second client device satisfies a proximity threshold;
determining that second location coordinates from the second client device were obtained more recently than the first location coordinates based on the first associated timestamp; and
providing the second location coordinates to the first client device.

8. A client device comprising:
a beacon detector to detect a plurality of beacons;
a processing device;
a memory coupled to the processing device; and
a proximity detector, executable by the processing device from the memory, to:
generate a first beacon signature indicating the plurality of beacons detected by the beacon detector;
provide the first beacon signature to a server; and
receive, from the server, an indication of a proximity of a second client device to the client device, wherein the proximity is determined in view of the first beacon signature and a second beacon signature from the second client device.

9. The client device of claim 8, wherein the first beacon signature comprises an identifier for each of the plurality of beacons detected by beacon detector and an indication of a detected beacon strength for each of the plurality of beacons.

10. The client device of claim 8, wherein the proximity detector further to:
receive, from the server an ordered list of a subset of a plurality of other client devices based on a proximity of the subset of the plurality of other client devices to the client device, wherein the ordered list comprises a relative proximity of each of the subset of the plurality of other client devices to the client device based on a number of beacons detected by both the other client devices and the beacon detector of the client device.

11. The client device of claim 10, wherein the plurality of other client devices are associated with at least one of the plurality of beacons detected by the beacon detector of the client device, and wherein the subset of the plurality of other client devices have associated beacon signatures which satisfy a proximity threshold with respect to the first beacon signature.

12. The client device of claim 10, wherein the first beacon signature comprises hash values corresponding to identifiers of a subset of the plurality of beacons detected by the beacon detector, the subset comprising beacons for which the hash values of the identifiers are the lowest among the hash values corresponding to identifiers of all of the plurality of beacons detected by the beacon detector.

13. The client device of claim 10, further comprising:
a location coordinate circuit to determine first location coordinates of the client device;
wherein the proximity detector further to:
provide, to the server, the first location coordinates with a first associated timestamp; and
receive, from the server, second location coordinates associated with a second client device that satisfies a proximity threshold with respect to the client device, wherein the second location coordinates were obtained more recently than the first location coordinates based on the first associated timestamp.

14. A non-transitory machine-readable storage medium storing instructions which, when executed, cause a processing device to perform operations comprising:
receiving a first beacon signature from a first client device, the first beacon signature indicating a plurality of beacons detected by the first client device;
determining a second beacon signature associated with a second client device, wherein the second client device is associated with at least one of the plurality of beacons detected by the first client device;
comparing, by the processing device, the first beacon signature to the second beacon signature; and
determining a proximity of the first client device and the second client device in view of the comparing of the first beacon signature and the second beacon signature.

15. The non-transitory machine-readable storage medium of claim 14, wherein the first beacon signature comprises an identifier for each of the plurality of beacons detected by the first client device and an indication of a detected beacon strength for each of the plurality of beacons.

16. The non-transitory machine-readable storage medium of claim 14, wherein the first beacon signature comprises identifiers of a subset of the plurality of beacons detected by the first client device, the subset comprising beacons for which the identifiers are the highest among the identifiers of all of the plurality of beacons detected by the first client device.

17. The non-transitory machine-readable storage medium of claim 14, the operations further comprising:
determining a plurality of other client devices that are associated with at least one of the plurality of beacons detected by the first client device;
determining beacon signatures for each of the plurality of other client devices;
comparing the beacon signatures for each of the plurality of other client devices to the first beacon signature; and
determining a subset of the plurality of other client devices for which the beacon signatures satisfy a proximity threshold with respect to the first beacon signature.

18. The non-transitory machine-readable storage medium of claim 17, the operations further comprising:
generating an ordered list of the subset of the plurality of other client devices based on a proximity of the subset of the plurality of other client devices to the first client device; and
providing the ordered list to the first client device.

19. The non-transitory machine-readable storage medium of claim 18, wherein generating the ordered list comprises determining a relative proximity of each of the subset of the plurality of other client devices to the first client device based on a number of beacons detected by both the other client devices and the first client device.

20. The non-transitory machine-readable storage medium of claim 14, the operations further comprising:
receiving first location coordinates with a first associated timestamp from the first client device;
determining that the second client device satisfies a proximity threshold;
determining that second location coordinates from the second client device were obtained more recently than the first location coordinates based on the first associated timestamp; and
providing the second location coordinates to the first client device.
